(19) United States
(12) Patent Application Publication
(10) Pub. No.: US 2007/0146215 A1
(43) Pub. Date: Jun. 28, 2007

(54) Shielding apparatus of notebook computer

(75) Inventors: Bo Peng, Shenzhen (CN); Qing-Bin Luo, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/527,921

(22) Filed: Sep. 27, 2006

(30) Foreign Application Priority Data
Dec. 23, 2005 (TW) 94222571

(51) Int. Cl. H01Q 1/24

(52) U.S. Cl. 343/702

(57) ABSTRACT

A shielding apparatus of a notebook computer includes an antenna, a control unit, a cable connected between the antenna and the control unit, a first ground unit connected to a shielding layer of the cable located in a first terminal between the cable and the control unit, and a second ground unit connected to the shielding layer of the cable neighboring a second terminal between the antenna and the cable.

### BACKGROUND OF THE INVENTION

1. Field of the Invention

The present invention relates to a shielding apparatus, and particularly to a shielding apparatus for reducing noise of electronic components in a notebook computer with wireless function.

2. General Background

A coaxial cable is a transmission medium in computer local area networks. The coaxial cable is composed of an interior conductor and an exterior conductor. The cable includes a core wire (interior conductor), an insulating layer, a shielding layer (exterior conductor), and a protective layer.

Referring to FIG. 5, a typical wireless apparatus of a notebook computer includes an antenna 10, and a wireless network card 14 connected to the antenna 10 through a coaxial cable 12. The coaxial cable 12 and the wireless network card 14 are placed in an enclosure of the notebook computer. The antenna 10 extends out the enclosure of the notebook computer for sending or receiving signals. A connection port between the wireless network card 14 and the coaxial cable 12 is connected to the shielding layer of the coaxial cable 12 forming a ground unit 16 to shield against noise.

However, when the wireless network card 14 transmits signals to the antenna 10, noise of electronic components occurring in the enclosure of the notebook computer is transmitted to the antenna 10 through the coaxial cable 12, therefore, the antenna 10 acting as a sending terminal transmits noise, inducing interference in a receiver terminal.

What is needed is a shielding apparatus of a notebook computer which reduces noise produced by internal electronic components.

### SUMMARY

An exemplary wireless apparatus of a notebook computer includes an antenna, a control unit, a cable connected between the antenna and the control unit, a first ground unit connected to a shielding layer of the cable located in a first terminal between the cable and the control unit, and a second ground unit connected to the shielding layer of the cable neighboring a second terminal between the antenna and the cable.

Other advantages and novel features will become more apparent from the following detailed description, in which:

### BRIEF DESCRIPTION OF THE DRAWINGS

FIG. 1 is a schematic view of a shielding apparatus of a notebook computer in accordance with a preferred embodiment of the present invention;

FIG. 2 is a cross-sectional view of a cable of FIG. 1;

FIG. 3 is an isometric view of the notebook computer with the shielding apparatus of FIG. 1;

FIG. 4 is an enlarged view of a circled portion IV of FIG. 3; and

FIG. 5 is a schematic view of a typical shielding apparatus.

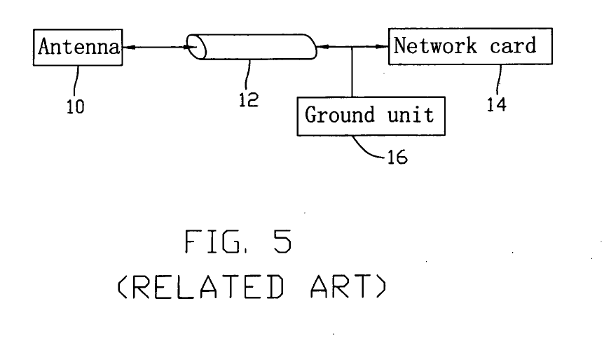

### DETAILED DESCRIPTION OF THE EMBODIMENTS

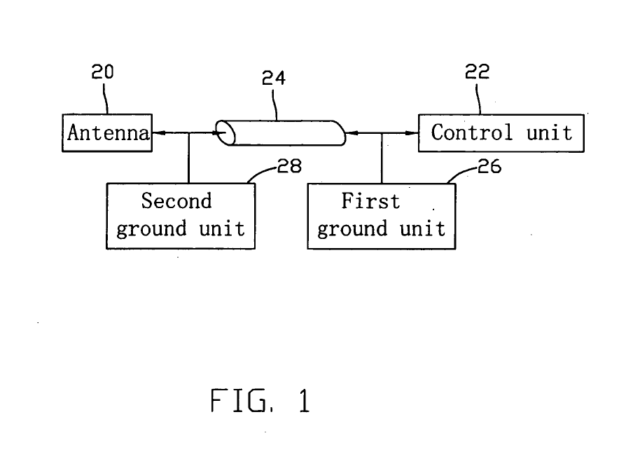

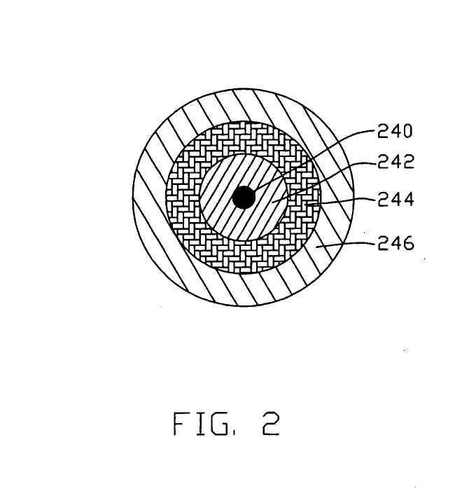

Referring to FIGS. 1 and 2, a shielding apparatus of an electronic device such as a notebook computer in accordance with a preferred embodiment of the present invention includes an antenna 20, a control unit 22, a cable 24 connected between the antenna 20 and the control unit 22, a first ground unit 26, and a second ground unit 28. The cable 24 is a coaxial cable, which includes a core wire 240, an insulating layer 242, a shielding layer 244, and a protective layer 246 in that order.

The first ground unit 26 is a ground terminal of a connection port between the control unit 22 and the cable 24. The ground terminal is connected to the shielding layer 244 of the cable 24. The control unit 22 is a wireless network card, used for converting signals with the antenna 20.

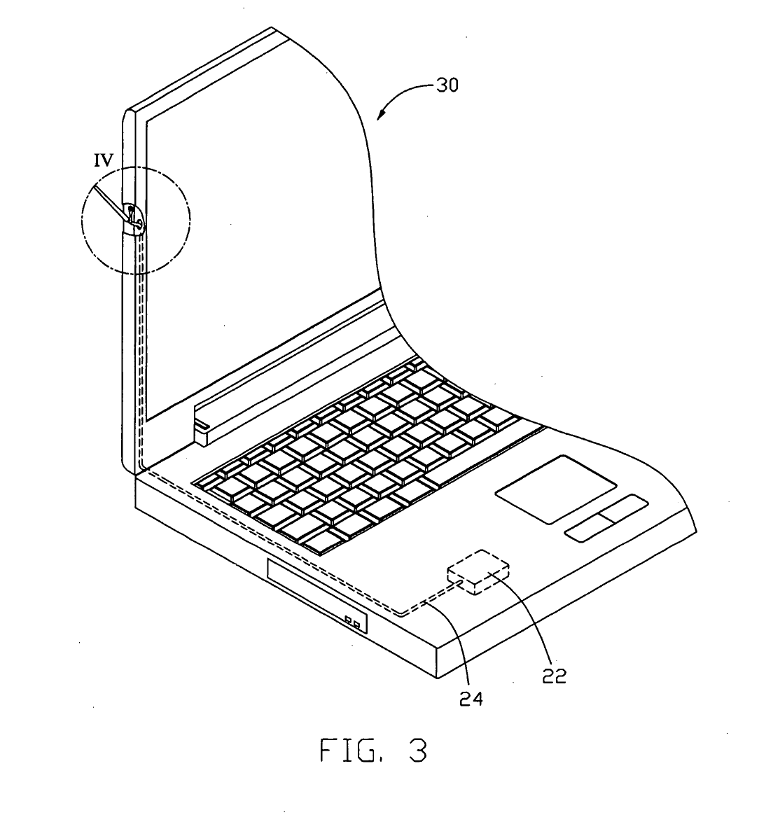

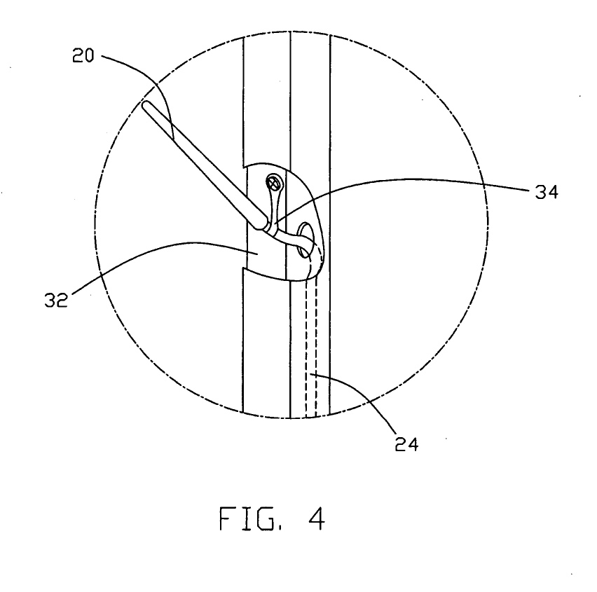

Referring to FIG. 3 and FIG. 4, the second ground unit 28 includes a conductive enclosure 32 of a notebook computer 30 and a conductive body 34 connected to the conductive enclosure 32. The conductive body 34 is connected to the shielding layer 244 of the cable 24 neighboring the antenna 20, for transmitting noise to earth through the conductive enclosure 32. In the embodiment, the conductive body 34 is a wire. In another embodiment, the conductive body 34 can be a conductive clamp or a conductive adhesive. The cable 24 and the control unit 22 are placed in the conductive enclosure 32 of the notebook computer 30. The antenna 20 extends out the conductive enclosure 32 of the notebook computer 30. Alternatively, more than one of the second ground unit 28 can be set to be located anywhere along the cable 24 between the antenna 20 and the first ground unit 26 if required.

When the control unit 22 communicates with the antenna 20, noise of the electronic components are grounded through the first ground unit 26 and the second ground unit 28, thus, the first ground unit 26 and the second ground unit 28 prevent the antenna 20 transmitting noise from internal electronic components.

Similarly, when the antenna 20 receives high frequency noise from outside of the notebook computer 30, the noise is grounded through the second ground unit 28. The first ground unit 26 and the second ground unit 28 ensure signal transmission and reception without noise interference.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A shielding apparatus of a notebook computer, comprising:
an antenna;
a control unit;
a cable connected between the antenna and the control unit;
a first ground unit connected to a shielding layer of the cable located in a first terminal between the cable and the control unit; and
a second ground unit connected to the shielding layer of the cable neighboring a second terminal between the antenna and the cable.

2. The shielding apparatus as claimed in claim 1, wherein the first ground unit is a ground terminal of the first terminal.

3. The shielding apparatus as claimed in claim 1, wherein the second ground unit comprises a conductive enclosure and a conductive body connected to the conductive enclosure, the conductive body is connected to the shielding layer of the cable neighboring the antenna.

4. The shielding apparatus as claimed in claim 1, wherein the cable comprises a coaxial cable.

5. The shielding apparatus as claimed in claim 1, wherein the control unit comprises a wireless network card.

6. A shielding apparatus comprising:
a cable comprising two terminals respectively connected between an antenna and a control unit; and
a first ground unit and a second ground unit connected to a shielding layer of the terminals of the cable, for preventing noise of electronic components in an enclosure of a notebook computer being transmitted from the control unit to the antenna.

7. The shielding apparatus as claimed in claim 6, wherein the first ground unit comprises a ground terminal of one of the terminals located in the control unit.

8. The shielding apparatus as claimed in claim 6, wherein the second ground unit comprises a conductive enclosure and a conductive body connected to the conductive enclosure, the conductive body is connected to a shielding layer of the cable neighboring the antenna.

9. The shielding apparatus as claimed in claim 6, wherein the cable comprises a coaxial cable.

10. The shielding apparatus as claimed in claim 6, wherein the control unit comprises a wireless network card.

11. An electronic device comprising:
an antenna extending outside said electronic device for wireless signals transmission;
a control unit installable inside said electronic device for wireless signal treatment;
a cable extending from said antenna to said control unit inside said electronic device for electrically connecting said antenna with said control unit to transmit wireless signals therebetween, said cable comprising an electrically conductive shielding layer surrounding said cable for noise shielding;
a first ground unit electrically connectable with said shielding layer of said cable around a connection of said cable and said control unit for grounding noise; and
a second ground unit electrically connectable with said shielding layer of said cable at a location definable along said cable between said antenna and said first ground unit for grounding noise.

12. The electronic device as claimed in claim 11, wherein said location of said second ground unit is located around a connection between said antenna and said cable.
